(19) United States
(12) Patent Application Publication
(10) Pub. No.: US 2001/0049773 A1
(43) Pub. Date: Dec. 6, 2001

(54) Fabric cache

(76) Inventor: Shyamkant R. Bhavsar, Los Altos, CA (US)

Correspondence Address: Tarek N. Fahmi, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/876,430

(22) Filed: Jun. 6, 2001

Related U.S. Application Data
(60) Provisional application No. 60/210,173, filed on Jun. 6, 2000.

(51) Int. Cl. G06F 12/00

(52) U.S. Cl. 711/147; 709/203; 711/118

(57) ABSTRACT

A network includes one or more server(s), switching fabric(s), and storage devices and provides for using a plurality of cache devices connected to the switching fabric. Data cached in the cache devices is available to the server(s). The cache devices may be interconnected by a cache fabric, and at least one of the cache devices may be simultaneously connected to the switching fabric. Further, the cache fabric and the switching fabric may operate by sharing common control and management. In some cases, the cache fabric and that switching fabric are merged into a single fabric.

### RELATED APPLICATION

The present application is related to and hereby claims the priority benefit of U.S. Provisional Application No. 60/210,173, entitled “Fabric Cache”, filed Jun. 6, 2000, by the present inventor.

### FIELD OF THE INVENTION

The present invention relates to the field of information storage devices and systems and, in particular, to a cache that can be used for the caching needs of any storage system, storage device, server or any end device connected to or within a fabric.

### BACKGROUND

A Storage Area Network (SAN) is typically used in data centers with a distributed network architecture that requires continuous operations, contains mission-critical applications, and uses a main-frame type computer for data storage. In a typical data-center environment a significant fraction of the network traffic involves data storage and retrieval. A SAN is an extension of an input/output (I/O) bus that provides for direct connection between storage devices and clients or servers. SAN, rather than using a traditional local area network (LAN) protocol such as Ethernet, uses an I/O bus protocol such as SCSI or Fibre Channel. A SAN is another network that is implemented with storage interfaces, enables the storage to be external to the server, and allows storage devices to be shared among multiple hosts without affecting system performance.

There are three primary components of a SAN:

1. Interface—The Interface is what allows storage to be external from the server and allow server clustering. SCSI, Fibre Channel, and other protocols are common SAN interfaces.

2. Interconnect—The Interconnect is the mechanism these multiple devices exchange data. Devices such as multiplexes, hubs, routes, gateways, switchers and directors are used to link various interfaces to SAN fabrics.

3. Fabric—the platform (the combination of network protocol and network topology) based on switched SCSI, switched Fibre, etc. The use of gateways allows the SAN to be extended across WANs.

To summarize then, in SANs all storage systems and devices are connected together by means of a network, which is formed by means of the interconnection of switches, hubs, routers, gateways, etc. The performance of the entire SAN depends on how fast the hosts can access (read and write) the storage devices. In order to achieve high read/write rate, some storage systems employ huge cache with elaborate caching algorithms. These systems with huge cache, such as 32 GB in EMC's Symmetrix 8000 disk storage system, are very expensive. Each of these storage systems can further boost its individual's performance by increasing the size of its cache. However adding cache to a particular storage system can only boost the performance of that particular storage system.

### SUMMARY OF THE INVENTION

In one embodiment, a network that includes one or more server(s), switching fabric(s), and storage devices provides is configured with a plurality of cache devices connected to the switching fabric. Data cached in the cache devices is available to the server(s). The cache devices may be interconnected by a cache fabric, and at least one of the cache devices may be simultaneously connected to the switching fabric. Further, the cache fabric and the switching fabric may operate by sharing common control and management. In some cases, the cache fabric and the switching fabric are merged into a single fabric.

In another embodiment, a network that includes one or more server(s), switching fabric(s), and storage devices provides for using at least one cache device connected to the switching fabric; and caching data in the cache device to make it available to the server(s).

Yet another embodiment provides a network that includes one or more server(s), switching fabric(s) and storage devices; wherein a plurality of cache devices are embedded within the switching fabric; and data is cached in the cache devices to make it available to said server(s). The cache devices may be interconnected by a cache fabric, and at least one the cache device may be simultaneously connected to the switching fabric. The cache fabric and the switching fabric should preferably operate in conjunction with one another, sharing common control and management. In some cases, the cache fabric and the switching fabric may be merged into a single fabric.

A further embodiment allows for the use, in a network including one or more of server(s), switching fabric(s) and storage devices; of a plurality of cache devices collocated with the servers; such that data in the cache devices is available to the server(s).

### BRIEF DESCRIPTION OF THE DRAWINGS

The present invention is illustrated by way of example, and not limitation, in the figures of the accompanying drawings in which:

FIG. 1 illustrates and example of a storage area network;

FIG. 2 illustrates a fabric cache configured in accordance with an embodiment of the present invention wherein storage devices are connected to an FCID directly;

FIG. 3 illustrates one example of a network configured in accordance with an embodiment of the present invention, specifically a high availability configuration with two FCIDs;

FIG. 4 illustrates one example of a network configured in accordance with a FIG. 3 embodiment of the present invention, specifically a high availability configuration with three FCIDs;

FIG. 5 illustrates one example of a network configured in accordance with a FIG. 3 embodiment of the present invention, specifically a high availability configuration with multiple FCIDs;

FIG. 6 illustrates one example of a network configured in accordance with an embodiment of the present invention, wherein hosts are connected to FCIDs;

FIG. 7 illustrates one example of a network configured in accordance with a FIG. 6 embodiment of the present invention, specifically a high availability configuration with two FCIDs;

FIG. 8 illustrates one example of a network configured in accordance with a FIG. 6 embodiment of the present invention, specifically a high availability configuration with three FCIDs;

FIG. 9 illustrates one example of a network configured in accordance with a FIG. 6 embodiment of the present invention, specifically a high availability configuration with multiple FCIDs;

FIG. 10 illustrates a general case example of a network configured in accordance with an embodiment of the present invention, specifically a high availability configuration with multiple FCIDs; and

FIG. 11 illustrates an example of a cache coherency mechanism for use with the scheme shown in FIG. 10.

### DETAILED DESCRIPTION

Described herein is a fabric cache. Although discussed with reference to certain illustrated embodiments, these examples should not be read as limiting the present invention.

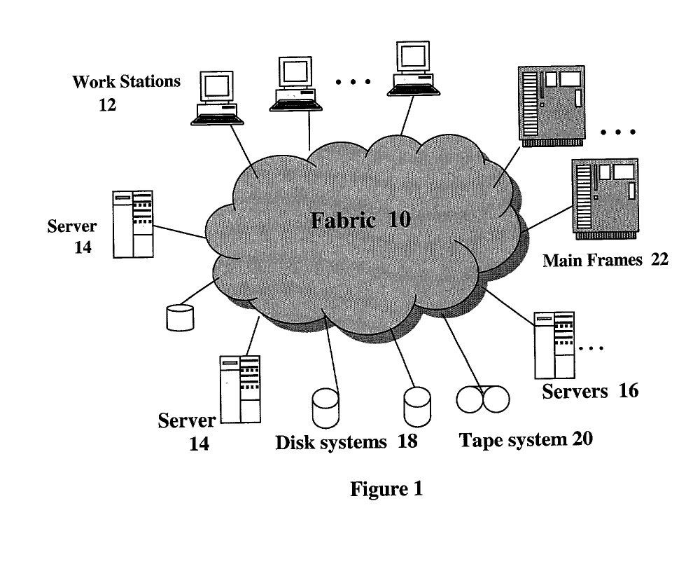

As discussed above, the SAN switching fabric, which includes an interconnection of switches, hubs, routers, gateways, etc., is the heart of all data flow, i.e., data always passes through the fabric before reaching its destination, as shown in FIG. 1. Fabric 10 provides an interconnection for various work stations 12, local and remote servers 14 and 16, respectively, disk storage systems 18, tape storage systems 20 (and other storage systems (not shown), and other computer (e.g., main frame) computer systems 22. However, as shown in the illustration, the storage systems in a conventional SAN all lie outside the fabric 10. A superior choice for location of cache memory is within the fabric 10 itself. Providing a cache in the fabric 10 has the following advantages:

1. A cache in the fabric can be used by all data passing there through and, hence, can benefit all storage systems, servers, devices, etc. With the help of a moderate size fabric cache, even low cost storage systems can have performance as high as those of high-end, expensive storage systems. With the proposed arrangement, in most cases, a user would need to purchase only low-end storage systems and thus save costs.

2. Performance of the total SAN is better when distributed caches in all storage systems are consolidated and thus shared in the fabric cache. It is known that a consolidated cache has better performance than a smaller distributed cache, although the consolidated cache size is smaller than the overall distributed cache sizes added together.

3. With a fabric cache, distributed caches can reduce their sizes and thus reduces the total system cost.

4. When a cache hit in a fabric cache occurs, it does not require sending requests to a separate storage system, and thus faster response times can be achieved.

Introduction to the Fabric Cache

As used herein, the term fabric cache is meant to refer to a cache that can be used for the caching needs of any storage system, storage device, server or any end device connected to or within the fabric. This means the fabric cache is accessible from any device connected to or within the fabric. Other terms used in this Specification are:

Fabric: A network which includes but is not limited to the interconnection of switches, hubs, routers, gateways, FCDs, ICDs, etc. The fabric may contain none, one or more of these infrastructure elements. If the fabric contains none of the infrastructure elements, the fabric is then an empty set, i.e., does not exist.

FICD: can be an FCD or an ICD (i.e., a Fabric or Infrastructure Cache Device, respectively).

FICD Fabric: A network that includes only FICDs. The fabric may contain none, one or more FICDs. If the FICD fabric contains none of the FICDs, the fabric is an empty set, i.e., the FICD fabric does not exist.

Storage Device: In this Specification when the term “storage device” is used it represents any storage device which includes but is not limited to a hard disk, disk storage system, disk array, disk RAID System, JBOD, tape device, tape system, tape library, etc.

As indicated above, there are basically two types of fabric cache. The first is a Fabric Caching Device (FCD). This is a caching device located within the fabric. Its main responsibility is caching of data passing through the fabric. A server, which wants to issue a read command (such as a SCSI read command) to a storage device attached to the network, will request the read data from the caching device first. If there is a cache hit, the read data will be coming from the caching device. If there is a cache miss, the read command will be sent to the storage device. When the read data from the storage device passes through the fabric to the server, the FCD will also capture the data for caching purposes. FCDs are very scalable. They can be added to the network as needs arise.

The second type of fabric cache is an Infrastructure Cache Device (ICD). This type of fabric cache is located in or attached to other network infrastructure devices. This kind of fabric cache is considered physically part of a network infrastructure element. This fabric cache does not exist without the infrastructure device. On the other hand, the infrastructure device can still exist without the option of a cache within the device. For example this type of fabric cache can be located inside a switch, hub, router, gateway, etc.

Even though this type of cache (the ICD) is considered physically located inside a network infrastructure device, it is different from the cache inside a storage system, which can only be used to cache data within the storage system. The fabric cache within the network infrastructure device is available to all attached and interconnected devices.

As multiple infrastructure devices each having their own fabric cache may seem to make the fabric cache distributed, logically the total fabric cache size can still be considered consolidated since the use of each individual device's cache can be coordinated and allocated just like a single cache. This will be illustrated below.

Both types of fabric caches can co-exist together in a network. Both types of fabric caches are very scalable. As customer needs grow, the total fabric cache capacity can be increased either by adding cache memory to one or some devices of either type or by just adding another device with cache memory.

The total fabric cache can be considered a consolidation of all the sub-fabric caches of each individual device, since they can be managed by a single software management program for cache allocation, caching algorithms (e.g., coherency algorithms), cache sharing, etc.

Caching Capability of Fabric Cache

Although the fabric cache includes smaller FICD caches, the use of each FICD cache is coordinated through a Fabric Cache Server. The Fabric Cache Server is a new concept, similar to a name server for the switch fabric. The Fabric Cache Server identifies the capacity, type, functions and responsibility of each FICD cache. The functions of the Fabric Cache Server include:

a. Identify and save the size of cache of each FICD.

b. Identify and save the types of cache in each FICD:

i. DRAM,

ii. SRAM,

iii. EEPROM,

iv. Battery back-up,

v. Flash,

vi. Etc.

c. Assign caching functions for all or part of an FICD cache:

i. Read cache,

ii. Write cache,

iii. Second copy for write cache,

iv. Sequential or random access caching,

v. Primary mirroring cache (cache be used for normal caching functions),

vi. Secondary mirroring cache (for back up purpose with limited access),

vii. Cache segment sizes for each cache functional area.

d. Assign full or part of a physical or logical device(s) to be cached by FICD(s).

e. Allocation of cache for different caching needs.

As discussed below, the caching functions and assignment of physical and logical devices for caching can be assigned by the user through management means.

Management Capability for Fabric Cache

Effective use of cache memory is an important performance consideration. For example, sequential devices may not need any long term caching help, since cache hit probability is slim; instead sequential reads may need continuous read ahead support. Transaction operations only need small cache segments; allocating long cache segments all the time would waste cache memory. Customer management facilities, such as through web browser interface management tools, provide customers the following cache management capabilities. These user settings override the software algorithms as described below.

1. Enable/disable caching by port number on the FICD. If caching is enabled on a specific port of the FICD, all storage device data passing through the specified FICD port number, depending on the caching algorithm, may be cached by the FICD. If caching is disabled on a specific port of the FICD, all dirty data of a write back cache will be de-staged to the appropriate device and all read cache data for the storage devices connected (directly or indirectly) to the specific FICD port will be discarded.

2. Enable/disable caching of data by storage device node WWN, port WWN or DID.

3. For each enabled cache or caching type, specify the caching segment sizes: default size, exact size, minimum size and maximum size.

4. Enable/disable caching of data for I/Os of specific initiators or servers. The specific initiator can be identified by port WWN or SID/DID. The server can also be identified by node WWN.

5. Enable/disable caching for: read data, write data, or read and write data.

Intelligent Cache Algorithms

Acting alone or in conjunction with customer cache settings as described in the previous section, an FICD's intelligent cache algorithms can further enhance the total SAN throughputs.

On power up the fabric cache (all the FICD caches combined) parameters are set to default values. Before any normal I/O operations, as part of power up, those caching parameters as specified by customers will be set to such customer values. The caching parameters that have default values have been discussed above.

Afterwards the fabric cache's intelligent caching algorithms assume control. These algorithms can mainly be separated into two types.

Type one cache setting algorithms. These algorithms depend on the hints of the connected end devices, such as the host servers and storage devices. These include:

1. Hints from a host, such as caching mode page which can hint the cache segment size, sequential operations, random operations, read ahead, etc.

2. Hints from a storage device, such as a RAID Storage Device most probably should be cached with cache segment size of multiples of stripe depth.

Type two cache setting algorithms. These algorithms perform predictive caching depending on a set of I/O statistical data accumulated and maintained by the fabric cache. The statistical data includes read hit counters, write hit counters, read hit ratio per unit of time (which can be 1 second, 2 seconds, . . . ), write hit ratio per unit of time, locations (such as LBA #s, cylinder address, head address, etc.) of operations, timing of day, week and month etc. and the usage ratio of a cache segment, etc.

The statistical data provide I/O patterns in time, so the caching parameters will also be changed dynamically in time to achieve optimal throughputs, since I/O patterns will change with different host applications.

Application and Connection of FICD(s)

In the following sections, it will be shown how FICDs can be used and connected within the fabric.

In order for FICDs to be able to serve as effective cache devices, the data to be cached must pass through the designated FICDs. The following are ways to achieve this requirement:

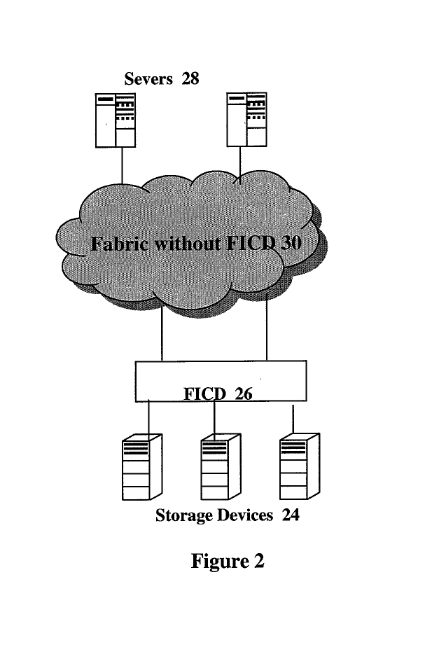

First, storage device(s) may be connected directly to FICD(s). In these configurations, all storage devices to be cached are connected to the FICDs. The FICDs are the only interfaces to the fabric or the storage devices. The storage devices have no direct connection to the fabric. This configuration is shown in FIG. 2. In this configuration, data to or from the storage devices 24 always passes through the FICD 26. Read and write data passing through the FICD 26 will be captured and stored in the cache memory of the FICD 26 as cache data. It is important that FICD 26 not only capture read/write data, but it also examine other control commands to understand the device type and caching hints, such as cache mode page, from the hosts, such as servers 28. Note, the fabric 30 has no FICDs in this configuration (i.e., it may be a conventional SAN fabric).

There are two implementation approaches to allow FICD captures of the data. In the first implementation, hosts 28 address storage devices 24 directly. In this approach the host I/Os address the storage devices 24 directly. The FICD 26 is transparent to the hosts/initiators 28. However as the read/write commands reach the FICD 26, the FICD 26 examines the command before passing the command to the storage devices 24. If the read results in a cache hit, the FICD 26 will respond to the command by sending data from its cache. The actual command will not be sent to the storage device 24. If the read command results in a cache miss, FICD 26 will pass the read command to the storage device 24 addressed by the initiator 28. As read data for the command is passing through the FICD 26 from the storage device 24, the FICD 26 will capture the read data to its cache.

In the second implementation, hosts 28 address FICDs 26 directly. In this approach the hosts/initiators 28 do not address the storage devices 24 directly. Instead, the initiators 28 send requests and commands to the FICD 26. If a read results in a read cache hit, the FICD 26 sends data from its cache and then passes an ending status command to the initiator 28. If the request results in a read cache miss, the FICD 26 will send a read command to the storage device 24. The FICD port appears to be a initiator to the storage devices 24. The storage device 24 responds to the request of the FICD 26 and sends data to the FICD 26. The FICD 26 will send appropriate data to the requesting hosts 28.

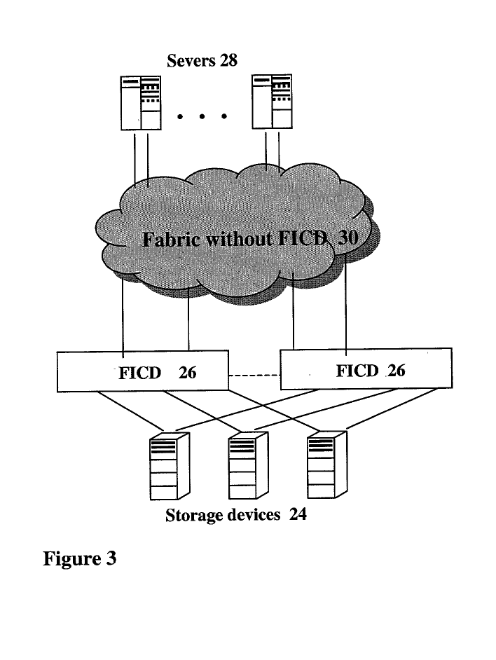

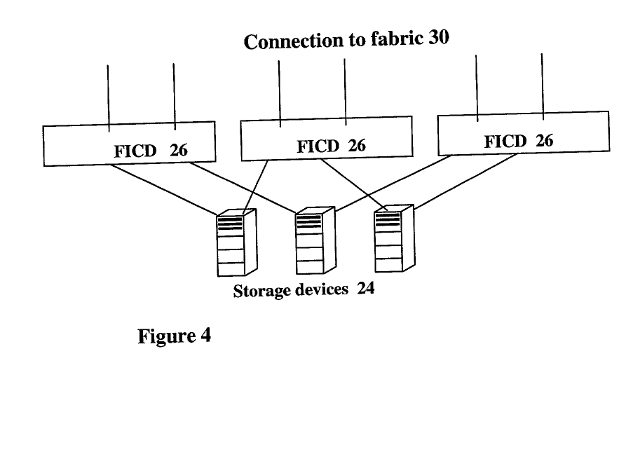

Either or both of these implementations may have high availability configurations, as shown in FIG. 3. In such embodiments there is always a redundant path between the hosts 28 for any storage device 24. In the high availability model, there are at least two FICDs 26 able to access any storage device 24. FIG. 3 shows a high availability configuration with two FICDs 26, both having access to all the storage devices 24. Notice that there exist possible connections between the two FICDs 26. When there are more than two FICDs 26, it is not necessary that all FICDs 26 have accesses to all the storage devices 24. FIG. 4 shows an example with FICDs 26 connected to three storage devices 24. Each FICD 26 can only access two of the storage devices 24 and this embodiment still provides redundant paths. Notice that there may be interconnections between the three FICDs 26 (not shown in FIG. 4).

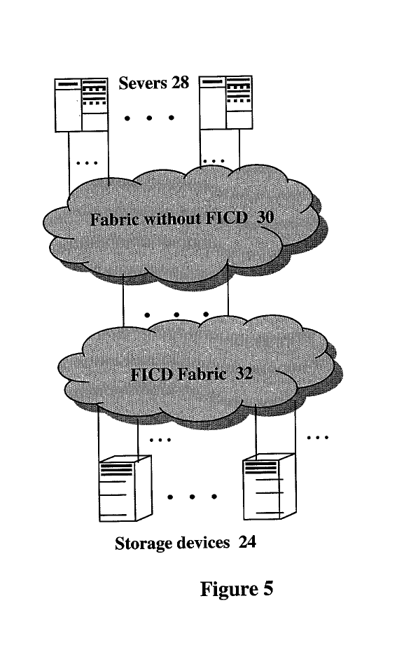

FIG. 5 shows a general configuration of storage device(s) 24 connected directly to an FICD fabric 32. Since an FICD fabric 32 contains none, one or more FICDs and there may be one or more storage devices 24 in the configuration, the FIGS. 2 through 4 implementations become special cases of the general configuration of the FIG. 5 embodiment. The configuration shown in FIG. 5 includes all the configurations where all the FICD(s) and storage device(s) are connected together. Notice that if the FICD fabric 32 in FIG. 5 does not contain any FICD elements, i.e., the FICD fabric does not exist, it becomes a normal fabric SAN connection. Also notice that if the fabric 30 in FIG. 5 contains no fabric elements, the fabric does not exist. In this case, both the servers 28 and storage devices 24 are connected directly to the FICDs.

The second way in which FICDs may be able to serve as an effective cache device is to allow the server(s) or host(s) to be connected directly to FICD(s). In these configurations, all data going to or from hosts or servers must pass through the FICDs. As data passes through the FICDs, the FICDs will capture the data for caching purpose.

Similar to the configurations where storage device(s) areconnected to FICDs directly, the host can address the storage devices directly or address the FICDs directly.

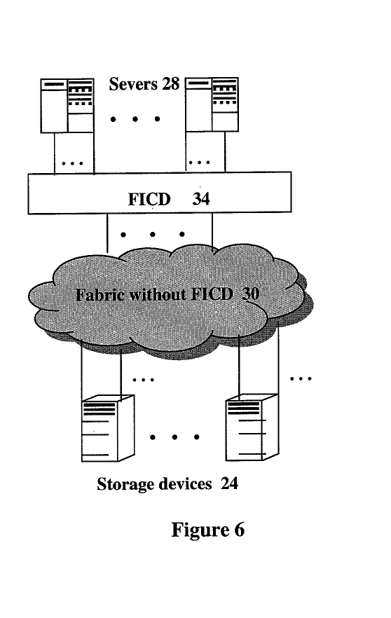

The case where host servers 28 are connected directly to an FICD 34, is shown in FIG. 6. In this configuration, the host servers 28 are connected directly to one FICD 34, so any I/O command and data between the hosts 28 and storage devices 24 connected to the fabric 30 will pass through the FICD 34. As data passes through the fabric cache device (FICD 34), the data is captured by the fabric cache for caching purpose.

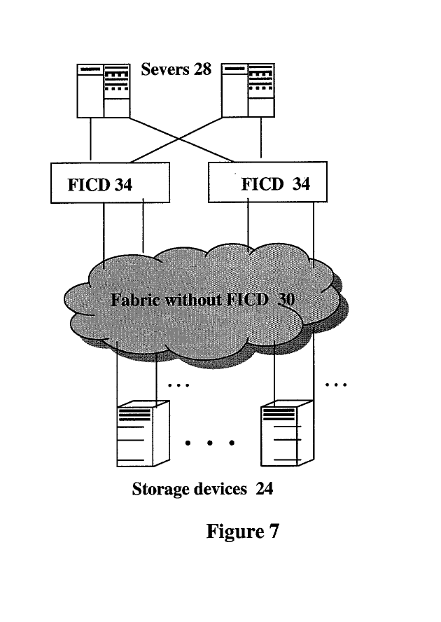

The configuration shown in FIG. 7 is for high availability, i.e., there is always a redundant path between the hosts 28 and any storage device 24. There may be connection(s) between the two FICDs 34 although these are not shown in the figure. In the high availability model, there are at least two FICDs 34 able to access any storage device 24. FIG. 7 shows a high availability configuration with two FICDs 34, both having access to all the storage devices 24 and servers 28. Notice that there exist possible connection(s) between the two FICDs 34.

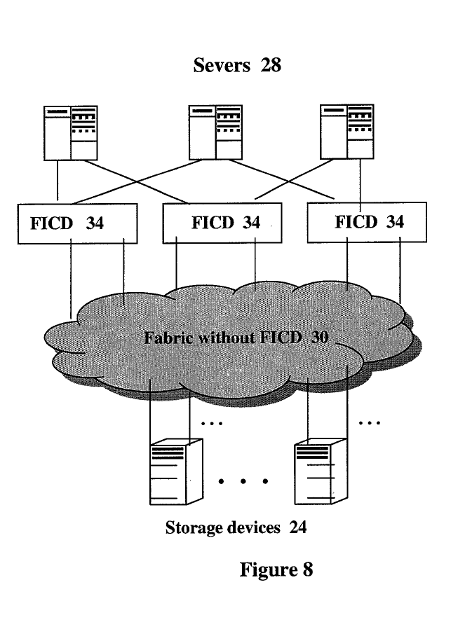

When there are more than two FICDs 34, it is not necessary that all FICDs 34 have access to all the servers 28. FIG. 8 shows three FICDs 34 connected to three servers 28. Each FICD 34 can only access two of the storage devices 24 and still provide redundant paths. Notice that there may be interconnections between the three FICDs 34 (not shown in FIG. 8).

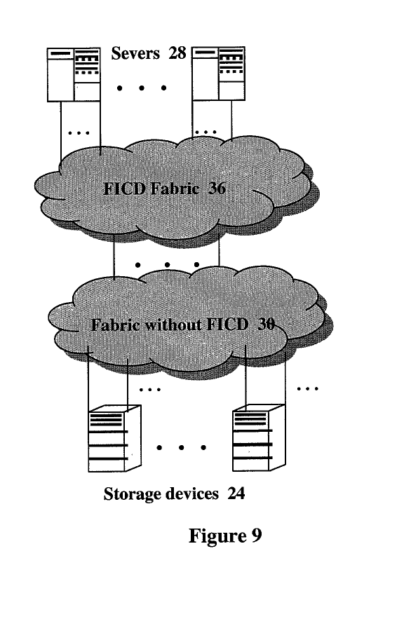

FIG. 9 shows a general configuration of host server(s) 28 connected directly to FICD(s). In the figure, the FICD fabric 36 may contain none, one or more FICDs. The number of servers 28 can be one or more. The number of storage devices 24 can also be one or more. With this in mind the configurations in FIGS. 6 to 8 become subsets of the configuration shown in FIG. 9.

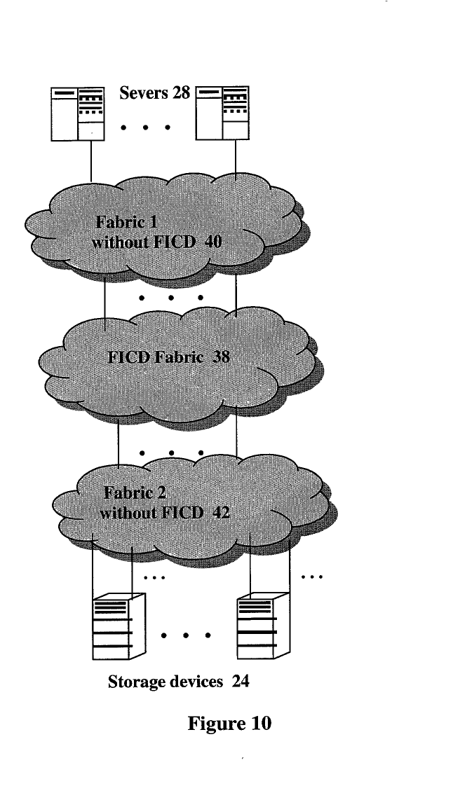

As discussed above, data always passes through an FICD Fabric. FIG. 10 shows the most general case where the data paths have to include an FICD fabric 38. All the configurations described above are special cases of the general configuration of FIG. 10. For example, if fabric 1 40 contains no infrastructure element, then it becomes similar to a FIG. 5 configuration. If fabric 2 42 contains no infrastructure element, then it becomes a FIG. 9 configuration.

SAN routes can be set up to always pass through FICDs. This can be done by setting up fabric paths between the servers and storage devices, such that all the I/O paths always pass through FICDs. The particular fabric path routes can be set up by using a fabric management tool. In this case, the FICD(s) can be located anywhere within the SAN, and all needed I/O paths still pass through the FICD(s).

Write caches may be included in FICD(s). In this case, the write data is saved in one or more FICD(s) before actual data is written onto disk or permanent media. The FICD receiving the command will respond with a good ending status indication after receiving all the write data into the fabric cache. The dirty data will be written to the disk later. The high availability model in this instance provides a mirrored write cache to ensure availability in case cache equipment failure occurs causing data loss/integrity.

Non-volatile write caches are used to protect data loss/integrity from power loss. This is used to perform fast writes where ending status is presented to an initiator after write data has been received into the non-volatile storage but before written down to permanent media such as disk. The high availability model here provides at least two copies in different cache/FICDs.

Snap shot copy (or point in time copy) functionality is also possible. During the snap shot copy, the copy is signaled as a completion immediately. The FICD keeps track of the delta when a write command is received. Applications can use both copies immediately. The algorithm is as follows: Before write data is written to disk, the FICD will read the corresponding current data into cache before overlaying old data with new data. This preserves the old data for copying purposes.

RAID function in FICD(s). In this case the parity and data disks of the same RAID group may be exist anywhere in the fabric. FC_AL loops of HDDs can be connected to the ports of FICD(s) and used in RAID.

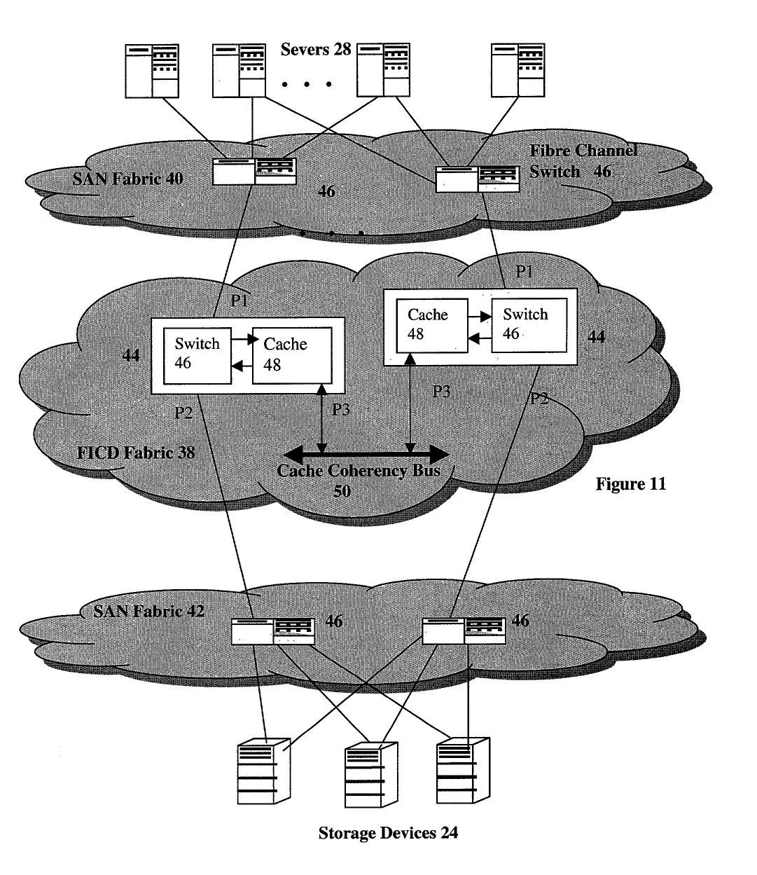

As indicated above, cache coherency is a consideration for the fabric cache. To understand how coherency is maintained refer to FIG. 11, which pictorially describes how storage gateways (i.e., examples of ICDs in an FICD fabric 38) 44 having various ports (P1, P2, P3, etc.) are connected in a typical Fibre Channel SAN (fabrics 40 and 42) implementation. As shown in this illustration, the storage gateways 44 include two sub-blocks, the first being a three-port fiber channel switch 46 and the second being the cache 48. The three ports of the switch 46 in each storage gateway 44 are:

Port P1 connecting to the fiber channel switch 46, which in turn connects to the servers 28;

Port P2 connecting to the fiber channel switch 46, which in turn connects to the storage devices 24; and

An internal port connecting the switch 46 to the cache 48.

In addition to these ports, each storage gateway 44 has a special port from the cache 48 (i.e., port P3) connected to a high-speed, bi-directional, private sub-fabric called the cache coherency bus 50. Port P3 is used for maintaining cache coherency across the distributed caches contained in the fabric 38. The cache coherency mechanism works as follows:

In the fiber channel SAN fabrics 40 and 42, there are basically data reads and data writes flowing across the network. The storage gateways 44 cache only read data. The write data is not cached. To maintain cache coherency, whenever a storage gateway 44 observers a write data command going across the network, it sniffs the address associated with the write data and keeps a copy of this address. This address is also provided to the storage gateway's cache 48 and is broadcast as a write address via port P3 to the cache coherency bus 50 (unidirectional or bi-directional), which is monitored by the other storage gateways 44 in the fabric 38. Next all the caches 48 (in the different gateways 44) look up this address and check to see if they have valid data associated with it. If there is a cache hit/match, the data associated with this address is simply invalidated. This maintains cache coherency across all the storage gateways 44 and storage devices 24.

Thus, a fabric cache has been described. Although discussed with reference to certain illustrated embodiments, the present invention should only be measured in terms of the claims that follow.

What is claimed is:

1. A method, comprising:
configuring, within a network that includes one or more server(s), switching fabric(s), and storage devices, a plurality of cache devices to be connected to the switching fabric; and
caching data in the cache devices to make the data available to the server(s).

2. A method, comprising:
configuring, within a network that includes one or more server(s), switching fabric(s), and storage devices, at least one cache device to be connected to the switching fabric; and
caching data in the cache device to make the data available to the server(s).

3. A method, comprising:
configuring, within a network that includes one or more server(s), switching fabric(s), and storage devices, a plurality of cache devices to be embedded within the switching fabric; and
caching data in the cache devices to make the data available to the server(s).

4. A method, comprising:
configuring, within a network that includes one or more server(s), switching fabric(s), and storage devices, a plurality of cache devices to be collocated with the servers; and
caching data in the cache devices to make the data available to the server(s).

5. The method of claim 1, wherein the cache devices are interconnected by a cache fabric, and at least one said cache device is simultaneously connected to the switching fabric.

6. The method of claim 3, wherein the cache devices are interconnected by a cache fabric, and at least one the cache devices is simultaneously connected to the switching fabric.

7. The method of claim 5, wherein the cache fabric and the switching fabric operate in conjunction with one another by sharing common control and management.

8. The method of claim 6, wherein the cache fabric and the switching fabric operate in conjunction with one another by sharing common control and management.

9. The method of claim 7, wherein the cache fabric and the switching fabric are merged into a single fabric.

10. The method of claim 8, wherein the cache fabric and the switching fabric are merged into a single fabric.

11. A system, comprising:
a network having one or more server(s), switching fabric(s) and storage devices, and including a plurality of cache devices connected to the switching fabric(s); and
the cache devices including cached data available to the server(s).

12. A system, comprising:
a network having one or more server(s), switching fabric(s) and storage devices, and including at least one cache device connected to the switching fabric(s); and
the cache devices including cached data available to the server(s).

13. A system, comprising:
a network having one or more server(s), switching fabric(s) and storage devices, and including a plurality of cache devices embedded within the switching fabric(s); and
the cache devices including cached data available to the server(s).

14. A system, comprising:
a network having one or more server(s), switching fabric(s) and storage devices, and including a plurality of cache devices collocated with the servers; and
the cache devices including cached data available to the server(s).

15. The system of claim 11, wherein the cache devices are interconnected by a cache fabric, and at least one of the cache devices is simultaneously connected to the switching fabric.

16. The system of claim 13, wherein the cache devices are interconnected by a cache fabric, and at least one of the cache devices is simultaneously connected to the switching fabric.

17. The system of claim 15, wherein the cache fabric and the switching fabric operate in conjunction with one another by sharing common control and management.

18. The system of claim 16, wherein the cache fabric and the switching fabric operate in conjunction with one another by sharing common control and management.

19. The system of claim 17, wherein the cache fabric and the switching fabric are merged into a single fabric.

20. The system of claim 18, wherein the cache fabric and the switching fabric are merged into a single fabric.

21. A method comprising:
in a first cache device, detecting a data write to a write address from a data source coupled to a fabric in which the cache is located to a data storage unit also coupled to the fabric in which the cache is located; and
invalidating data stored in the first cache device at an address corresponding to the write address.

22. The method of claim 21 further comprising broadcasting the write address to other distributed cache devices.

23. The method of claim 22 wherein the other distributed cache devices are located in the fabric and are coupled to the first cache device though a bus.

24. The method of claim 23 wherein for each of the distributed cache devices having data stored at an address corresponding to the write address, invalidating the data.
